(19) United States
(12) Patent Application Publication
(10) Pub. No.: US 2018/0087248 A1
(43) Pub. Date: Mar. 29, 2018

(54) PLUMBING ATTACHMENT SYSTEMS AND METHODS

(71) Applicant: OATEY CO., Cleveland, OH (US)

(72) Inventors: Douglas BUCHAN, Seville, OH (US); Joshua FUNK, Lodi, OH (US)

(21) Appl. No.: 15/562,452

(22) PCT Filed: Mar. 29, 2016
(86) PCT No.: PCT/US16/24748

§ 371 Date: Sep. 28, 2017

Related U.S. Application Data
(60) Provisional application No. 62/139,734, filed on Mar. 29, 2015.

(51) Int. Cl. E03C 1/24; F16L 41/14; E03C 1/22; E03C 1/26

(52) U.S. Cl. CPC E03C 1/24; E03C 1/26; E03C 1/22; F16L 41/14

(57) ABSTRACT

A plumbing attachment system according to a first embodiment includes a pipe, a flexible spud, and a gasket. The flexible spud may be sealingly attached to a hole in a tank to provide a liquid proof seal therebetween. The flexible spud includes a flexible ring portion, which enables the system to be inserted into and to be retained within the hole of the tank. A plumbing attachment system according to a second embodiment comprises a new pipe, drain gasket, collar, and compression gasket, where the system is configured for attachment to an existing pipe construct. In a third embodiment, the system includes a pipe-guiding connector, sized and dimensioned to mate with a pipe and to provide a guiding track (“shelf) for positioning the pipe relative to a hole in a tank for ease of installation. Methods of installing the attachment systems in plumbing applications are also disclosed.

### CROSS REFERENCE TO RELATED APPLICATIONS

This PCT Application claims the benefit of priority to U.S. Provisional Application No. 62/139,734, filed on Mar. 29, 2015, the entirety of which is incorporated herein,

### TECHNICAL FIELD

The present disclosure relates to plumbing attachment systems for the facilitation of installation, repair, and replacement of plumbing structures. The disclosure also relates to methods of installing the plumbing attachment systems.

### BACKGROUND

Plumbing repairs are complex in nature, and typically involve the costly work of a skilled plumbing technician. Oftentimes, plumbing work will require the active involvement of more than one individual due to the nature of the plumbing equipment and required tools. That is, because pipes and pipe attachment pieces need to be held in place while installation is done using an assortment of different tools, installation by a single person is difficult if not entirely impossible. Due to the complexity of the work as well as the need to work in cramped spaces, plumbing work can be extremely time-consuming. The present invention provides a plumbing attachment system that does not require the use of a plumbing technician. In other aspects, the invention relates to features that simplify installation and permit installation by a singular person in a shortened period of time. In still further aspects, the invention facilitates installation of the attachment system onto existing pipes that may be unevenly or poorly cut so as to reduce or eliminate clogs in a drain pipe.

### SUMMARY OF THE INVENTION

A plumbing attachment system according to a first embodiment includes a pipe, a flexible spud, and a gasket. The pipe has first and second openings spaced along the pipe's length, where the first opening is configured to connect to a liquid-filled tank. The pipe may comprise an elbow-shaped body, although any configuration of the pipe body is contemplated within the scope of this disclosure. The first opening is further configured to receive the flexible spud therein. The pipe's body near the first opening contains interior threading which is complementary with exterior threading on the body of the flexible spud so as to permit threaded engagement therebetween. The flexible spud has a generally cylindrical body and it includes a flexible ring portion at its top. The flexible ring portion has a maximum outer diameter that is greater than the diameter of the spud body, and the ring portion includes a flexible material disposed about a rigid frame. The flexible ring further includes an outer tapered section which tapers downwardly and away from the center of the flexible spud, such that when the flexible ring is connected to the tank at the first opening, the flexible ring is configured to provide a leak-proof seal between the system and the tank.

The attachment system of the first embodiment may also include a plumbing tool, such as a spud engagement tool, and a trim. The plumbing tool facilitates attachment of the flexible spud to the pipe. The tool contains an engagement feature that complements an engagement feature of the flexible spud. Engagement of these features allows the tool to adjust a distance between the flexible spud and the pipe from a first distance to a second distance. In a first aspect, the second distance may define a reduced distance that is less than the first distance by, for example, imparting relative rotation of the flexible spud, via the tool, relative to the pipe so as to engage complementary threading of the pipe and the flexible spud. Other methods of reducing the distance as known in the art are also contemplated. The plumbing tool itself may comprise any tool known in the art that would facilitate rotational adjustment of the flexible spud relative to the elbow pipe. For example, the plumbing tool may comprise a spud engagement tool that is specifically sized and configured to mate with the flexible spud of the attachment system.

A pipe-guiding connector according to a first embodiment is sized and dimensioned to mate with an pipe so as to position the pipe relative to the tank. The connector has a tank-facing surface that may adhere onto a surface of the tank so as to positionally fix the connector relative to the tank. The connector generally has a horseshoe-shaped body that includes both a pipe-holding portion and a pipe-guiding portion. The body of the connector includes a shelf that is sized and dimensioned to abut a flange of the pipe such that the lower surface of the flange may ride along a surface of the shelf from the pipe-guiding portion to the pipe-holding portion. The pipe-guiding portion further includes a locking mechanism which engages with the pipe to retain the pipe within the pipe-holding portion. Although the pipe-guiding connector may be used independently of the attachment system according to the first embodiment, it may also be used with the attachment system according to the first embodiment—including any number of the system's components, up to an including all of the disclosed elements—without departing from the scope of this disclosure.

In another embodiment a plumbing attachment system includes a newpipe, a drain gasket, a collar, and compression gasket. When assembled, these components act to create a seal (e.g., a liquid-proof seal) between the new pipe and an existing pipe. The new pipe may define a pipe body that has a generally circular cross-section. And the body may define two pipe segments: the first pipe segment has two openings separated along a first axis, while the second pipe segment has a third opening spaced from the first portion along a second axis that is perpendicular to the first axis. It should be understood, however, that the new pipe may have any configuration known in the art: it may include any number of pipe segments, having various respective arrangements, without departing from the scope of this disclosure. For example, the new pipe may include a singular segment, which may be bent or straight. The drain gasket of the system has a generally cylindrical body that is defined by an outer cylindrical wall extending about a gasket axis and having a first diameter that is substantially equal to an inner diameter of an existing pipe. The gasket body also includes a sealing element near the top portion of the gasket which extends radially outward from body relative to the axis such that the diameter of the sealing element is both (1) greater than that of the outer cylindrical wall, and (2) substantially equal to the first pipe segment of the new pipe near the first opening and also. The sealing element acts to create a seal with the inner wall of the new pipe to prevent leaking (e.g., of a liquid) therefrom. The collar has a generally cylindrical body extending along a longitudinal axis and it defines at least two tabs extending longitudinally out from the top of the collar body. The collar further includes an array of teeth extending radially inward near the bottom of the collar. The compression gasket is sized and dimensioned to be received in and cooperate with the collar so as to create a seal between the new pipe and the existing pipe. In the assembled configuration, the drain gasket is received within the existing pipe such that a bottom surface of the sealing element abuts a top edge of the existing pipe so as to create a first liquid-proof seal therebetween. The existing pipe is received within the first pipe segment of the new pipe at the first opening to define a juncture point where the first opening overlaps the existing pipe. The collar receives the compression gasket and slides along the existing pipe to create a compressive force at the juncture point to thereby form a second liquid-proof seal between the new pipe and the existing pipe, whereby the teeth of the collar abut an exterior surface of the existing pipe so as to create a frictional force therebetween.

A further aspect of the present disclosure is a method for installing plumbing attachment systems. The method begins by interconnecting a flexible spud with a pipe to define a pre-assembled plumbing assembly. It is understood that the interconnecting step may be accomplished by the user acquiring the assembly for installation already in the pre-assembled configuration. The method continues by inserting the pre-assembled plumbing assembly along an insertion direction into a hole of a tank such that a flexible ring portion of the flexible spud is disposed within the tank. The inserting step may further include pressing the flexible ring portion of the flexible spud against an outer tank surface at an edge of the desired hole so as to cause the flexible ring portion to flex inwardly toward a body of the flexible spud so as to temporarily define a reduced diameter that is less than the first outer diameter in order to allow the flexible spud to pass through the desired hole and into the interior of the tank, wherein the desired hole has a diameter that is less than the first diameter but greater than the reduced diameter, and wherein the flexible ring flexes outwardly away from the body of the flexible spud so as to once again define the first outer diameter after the entirety of the flexible ring passes into the interior of the tank. The method continues by engaging an engagement feature of a first end of a plumbing tool, such as a spud engagement tool, with a complementary engagement feature of the flexible spud. The method then continues by imparting momentum to the tool so as to reduce a distance between the flexible spud and the pipe measured along the direction of insertion. The imparting step may include rotating the tool so as to cause the flexible spud to ride along the inner threading of the pipe. Next, the method involves discontinuing the imparting step when both: (1) an upper surface of the gasket abuts the outer surface of the tank adjacent to the desired hole, and (2) a bottom of the flexible ring portion contacts an inner surface of the tank so as to cause the flexible ring portion to flex outwardly from the flexible spud body so as to define a second outer diameter that is greater than the first outer diameter. The method concludes by disengaging the tool from the engagement feature of the flexible spud.

The plumbing attachment method indicated above may further include a method of inserting a trim into the flexible spud. The additional method begins after the disengaging step by engaging an engagement feature of a plumbing tool, such as a second end of the spud tool, with a complementary engagement feature disposed in an inner surface of a trim. The method continues by introducing the engaged trim into the engagement feature of the flexible spud so as to cause an engagement feature of an outer surface of the trim to engage with the engagement feature of the flexible spud so as to positionally fix the trim relative to the flexible spud. The method concludes by disengaging the second end of the spud tool from the engagement feature of the trim. The method may further include, prior to the disengaging step, imparting momentum to the trim via the tool so as to engage the outer engagement feature of the trim with a second complementary engagement feature of the flexible spud.

Another aspect is a method of repairing existing plumbing systems. The method begins by inserting a collar and then a compression gasket onto and around an exterior cylindrical surface of an existing pipe so as to engage a friction mechanism with the existing pipe so as to limit translation of the collar with respect to the existing pipe. The friction mechanism may comprise an array of teeth extending inwardly toward the exterior cylindrical surface. The method continues by securing a drain gasket to the existing pipe at a top edge thereof, the drain gasket having a cylindrical gasket body extending from a top portion to a bottom portion along a gasket axis, the gasket further including a bore extending completely therethrough, the bore being defined by an outer cylindrical wall, the gasket including a sealing element at a top portion of the body, wherein the sealing element is sized and dimensioned to be disposed on the top edge of the existing pipe and the outer cylindrical wall is sized and dimensioned to match a cross-sectional inner diameter of the existing pipe. The method continues by fitting an opening of a tee pipe over the existing pipe at the top edge so as to cause the exterior cylindrical surface of the existing pipe at the top end to thereby face an inner cylindrical surface of the tee pipe at the opening, wherein the intersection of the opening of the tee pipe with the exterior cylindrical surface of the existing pipe defines a juncture point, wherein a cross-sectional diameter of the tee pipe matches the diameter of the sealing element to thereby create a first liquid-proof seal between the tee pipe and the drain gasket at a point of contact between the two. The method concludes by translating the collar toward the juncture so as to secure the tee pipe to the existing pipe, wherein the collar cooperates with the compression gasket to create an inwardly directed compressive force at the juncture to both (1) positionally fix the tee pipe relative to the existing pipe, and (2) create a second liquid-proof seal.

### BRIEF DESCRIPTION OF THE DRAWINGS

FIG. 1 is a perspective view of a plumbing attachment system in accordance with a first embodiment comprising both a drain assembly and an overflow assembly adjacent to respective points of attachment to a tub.

FIG. 2 is a detailed view of the drain assembly illustrated in FIG. 1, further comprising a trim kit.

FIG. 3 is a detailed view of the overflow assembly illustrated in FIG. 1, further comprising an overflow trim.

FIG. 4 is a detailed view of the drain assembly of FIG. 2 showing the flexible spud, tub gasket, and drain elbow in greater detail.

FIG. 5 is a perspective view of the drain assembly of FIG. 2 showing a trim kit and a spud tool, wherein the trim kit has been removed for cleaning of a blockage.

FIG. 6 is an illustration of a step-by-step installation method for installing any one of the drain assembly or overflow assembly of assembly of FIG. 1, the installation method further comprising the use of a spud tool.

FIG. 7 is a perspective, exploded view of a plumbing attachment assembly in accordance with a second embodiment comprising a tee-pipe, a drain gasket, a compression gasket, a collar, and an existing plumbing construct.

FIG. 8 is a perspective assembled of the plumbing attachment assembly as illustrated in FIG. 7.

FIG. 9 is a detailed view of the assembled plumbing attachment assembly as illustrated in FIG. 8.

FIG. 10 is a detailed view of the collar as illustrated in FIG. 7.

FIG. 11 is an illustration of a step-by-step installation method for installing the plumbing attachment assembly of FIG. 7.

FIG. 12 is a perspective view of a pipe-guiding connector (or third hand) configured to guide an elbow pipe to a respective point of attachment to a tub.

FIG. 13 is a perspective, exploded view of the pipe-guiding connector illustrated in FIG. 12, showing the features of the pipe-guiding connector.

FIG. 14 is an illustration of a step-by-step installation method for installing the pipe-guiding connector illustrated in FIG. 12 and utilizing it with the drain assembly in FIG. 2.

### DETAILED DESCRIPTION OF THE DRAWINGS

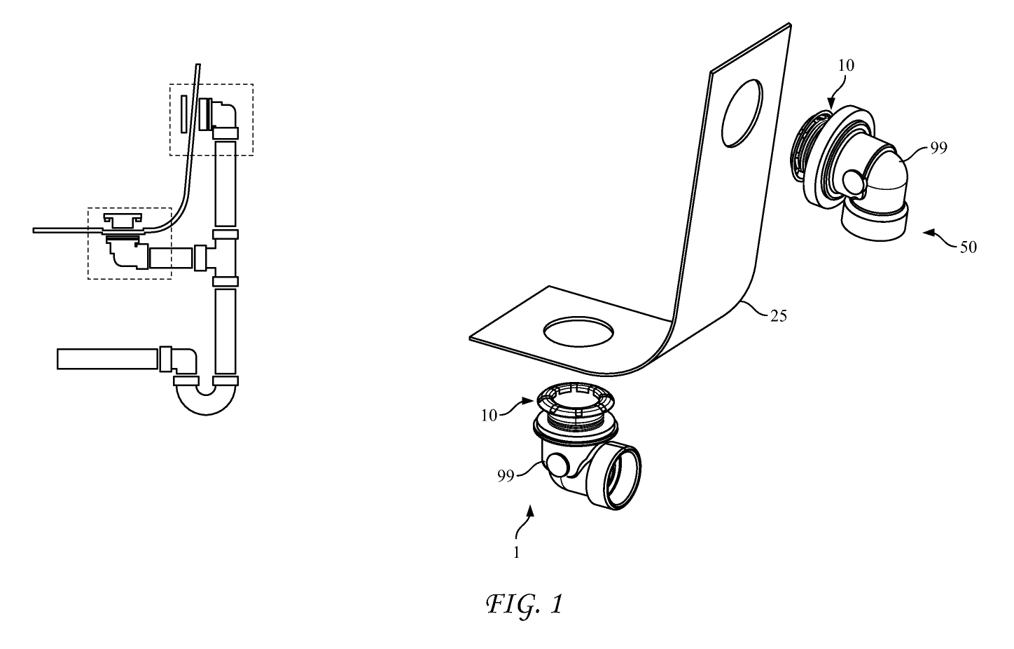

FIG. 1 depicts a plumbing attachment system for connecting at least one plumbing construct to a liquid-filled tank (or tub), such as a water tank (25). A typical plumbing construct is configured to provide drainage of liquid from the tank in at least two key locations—a drain and an overflow. As shown in FIG. 1, the system includes both a drain assembly (1) configured to connect to a bottom (drain portion) of the tank (25) and an overflow assembly (50) configured to connect to a side wall (overflow area) of the tank (25). As illustrated, both assemblies utilize an elbow-shaped pipe (90) (which may also be referred to as a “shoe”, “elbow pipe”, or “elbow”) to connect to additional plumbing constructs, although other pipe orientations, such as a substantially straight pipe, are also contemplated. In the embodiment shown in FIG. 1, both the drain assembly (1) and the overflow assembly (50) comprise a flexible spud (10), as will be described in greater detail below. In general, the flexible spud (10) permits simplified installation for the particular assembly being installed as well as liquid-proof sealing properties.

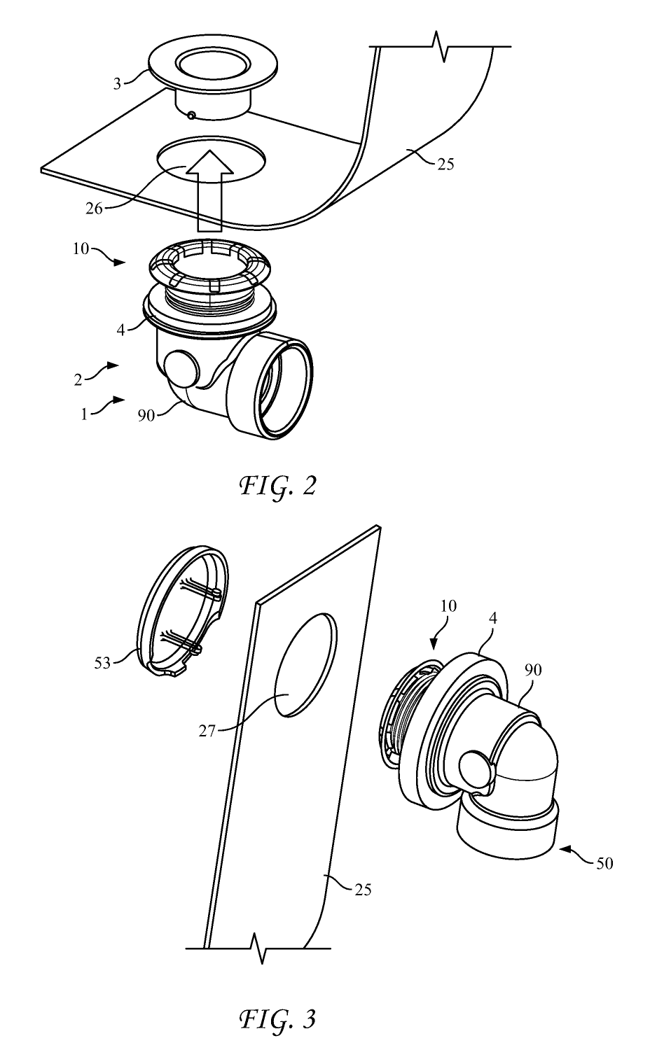

With reference now to FIGS. 2 and 3, the drain and overflow assemblies (1 and 50, respectively) are shown in greater detail. The drain assembly (1) shown in FIG. 2 generally comprises an attachment assembly (2) and a trim kit (3). The drain assembly (1) generally includes the elbow pipe (90), a gasket (4), and the flexible spud (10). As shown and as will be explained in greater detail below, the drain assembly (1) may be installed all together by inserting the assembly (1) upwardly (as shown) through a hole (26) in the tank (25). The trim kit (3) may be installed after the assembly (1) has been inserted into the tank (25). The same is generally true for the overflow assembly (50) shown in FIG. 3 where the assembly (50) is installed into a second hole (27) from outside of the tank (25) and an overflow trim kit (53) is installed into the assembly (50) afterward from inside the tank (25). As shown in FIGS. 2 and 3, the drain assembly (1) and the overflow assembly (50) are substantially identical to one another, except for the difference in trim design and their relative positioning on the tank (25). Therefore, the drain assembly (1) and overflow assembly (50) may each interchangeably be referred to as a plumbing attachment system. To the extent that succeeding figures relied upon in the description below may relate to either the drain assembly (1) or to the overflow assembly (50), it will be understood that reference to the “plumbing attachment system” may equally apply to both assemblies equally, except where the two assemblies differ as noted above.

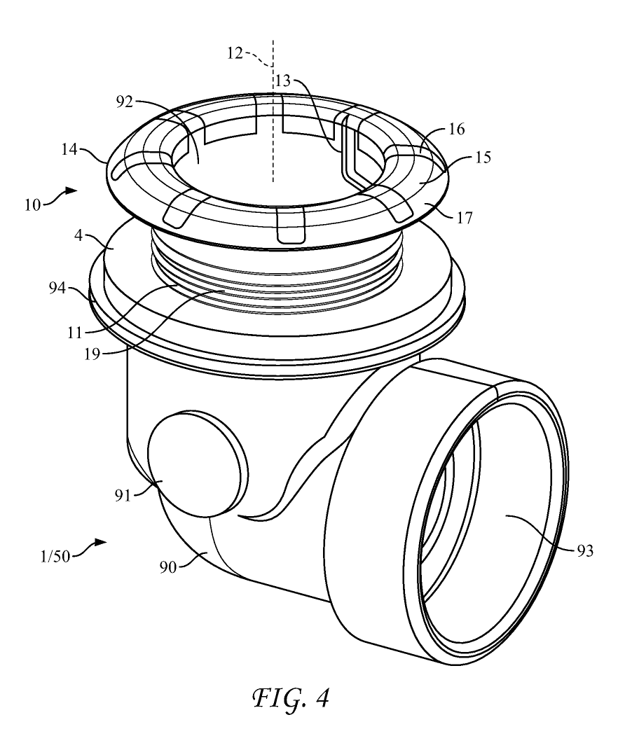

A plumbing attachment system—which could be used with a drain assembly (1) or overflow assembly (50)—is shown in greater detail in FIG. 4. The system generally includes the elbow pipe (90), the gasket (4) (or tub gasket), and flexible spud (10); each of which will be described now in detail.

The elbow pipe (90), as illustrated, is shown as a typical ninety-degree pipe having an overall shape reminiscent of a right-angle, although one of skill in the art will appreciate that elbow pipes having different angulations are also possible. As described above, although elbow pipe (99) is illustrated with the embodiment, pipes having other orientations, such as straight segment pipes, are also contemplated. Notably, the elbow pipe (90) comprises a pipe body (91) which has a generally circular cross-section throughout, although non-circular cross sections are also contemplated to be within the scope of this disclosure. The elbow pipe (90) may comprise any material known in the art to be suitable for pipes, including metals, plastics, or similar materials.

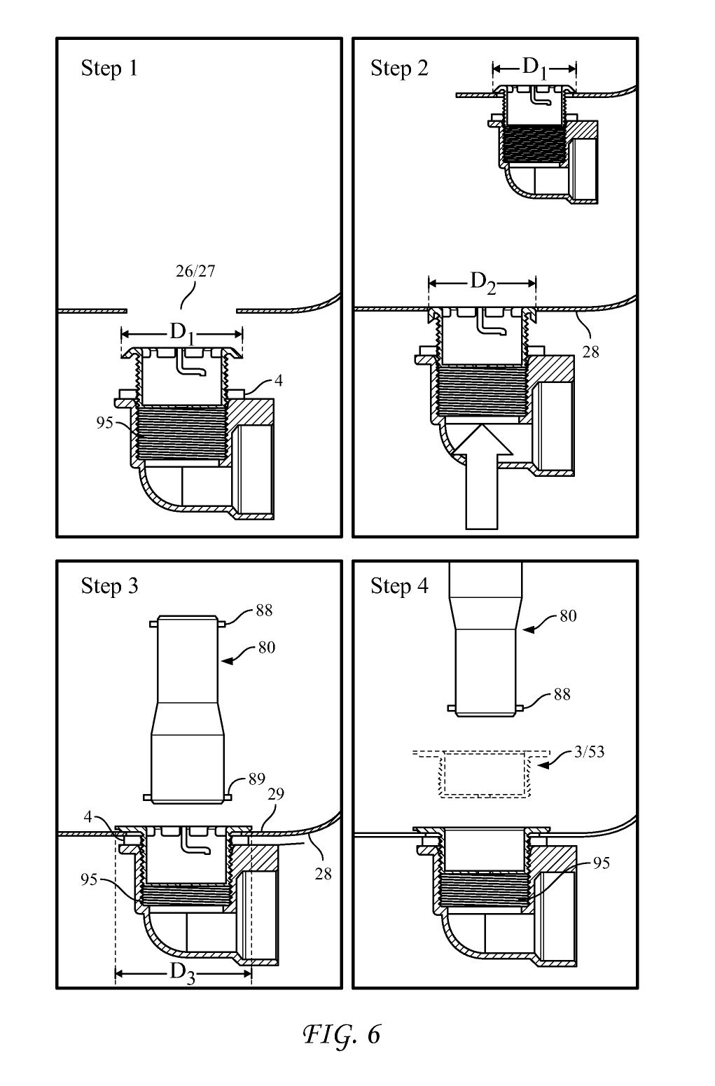

The elbow pipe (90) generally defines two straight, cylindrical pipe segments, joined together at by a corner segment. Each pipe segment of the elbow pipe extends generally about a respective segment axis of elongation. The elbow pipe has two openings at either end through which liquid may flow into and subsequently out of the pipe. As illustrated in FIG. 4, each opening has a circular cross section having an inner diameter reflecting the distance between the inner surfaces at the respective pipe opening. The opening on the top (“the first opening (92)”) is configured to accommodate the flexible spud while the bottom-right opening (“the second opening (93)”) is configured to attach to other pipe constructs (not shown). Near the first opening (92), the pipe body includes a flange (94) that projects radially outward from the first opening (92) with respect to the segment axis so as to define a substantially flat surface, which, as shown in FIG. 4, accommodates a gasket (4) (tub gasket). Also near the first opening (92), the pipe body (91) includes an attachment mechanism to allow the elbow pipe to attach to the flexible spud. As best shown in FIG. 6, a set of interior threading (95) extends into the interior surface of the pipe segment near the first opening (92) to accommodate the flexible spud (10). The form of attachment is not limited to threading in this respect, and one of skill in the art will readily understand that other forms of attachment (including but not limited to press fit or suction) may be used instead of threading. In a particular embodiment and for ease of reference with respect to FIGS. 4-6, the use of threading as the attachment mechanism will be further described. As detailed below with respect to the flexile spud (10), the interior surface threading (95) of the elbow pipe (90) complements external threading (19) on the flexible spud (10) so as to allow the flexible spud (10) to threadedly engage the elbow pipe (90).

The tub gasket (4), as illustrated, provides for a liquid-proof seal between an exterior of the tank (25) (or tub) and the elbow pipe when the elbow pipe is assembled and fully tightened with the tank (25). The gasket (4) is preferably made of a plastic or rubber material, although one of skill in the art will readily understand that any suitable flexible material know in the art may be used.

With continuing reference to FIG. 4, the flexible spud (10) is configured to engage with the elbow pipe (90) at the first opening (92). As described further below in greater detail, the flexible spud (10) is designed to be installed so as to create a liquid-proof seal with the tank (25), particularly with the interior of the tank (25). By saying the flexible spud (10) is “flexible,” it is contemplated that the flexible spud (10) will be able to adjust its size—particularly its maximum outer diameter—in order to facilitate installation of the plumbing system into the tank (25). This will also be described in greater detail below. As shown in the Figure, the flexible spud (10) has a generally cylindrical spud body (11) that extends downwardly from a top portion to a bottom portion along a longitudinal central axis (12). The spud body (11), as shown in FIG. 4, comprises a structural plastic material, however, one of skill in the art will readily understand that the spud body (11) can comprise any other appropriate material or combination of materials known in the art. The spud body (11) includes a hollow bore extending therethrough so as to allow liquid from the tank (once the system is installed) to pass through the hollow bore portion and ultimately through the elbow pipe (90) from the first opening (92) toward and through the second opening (93).

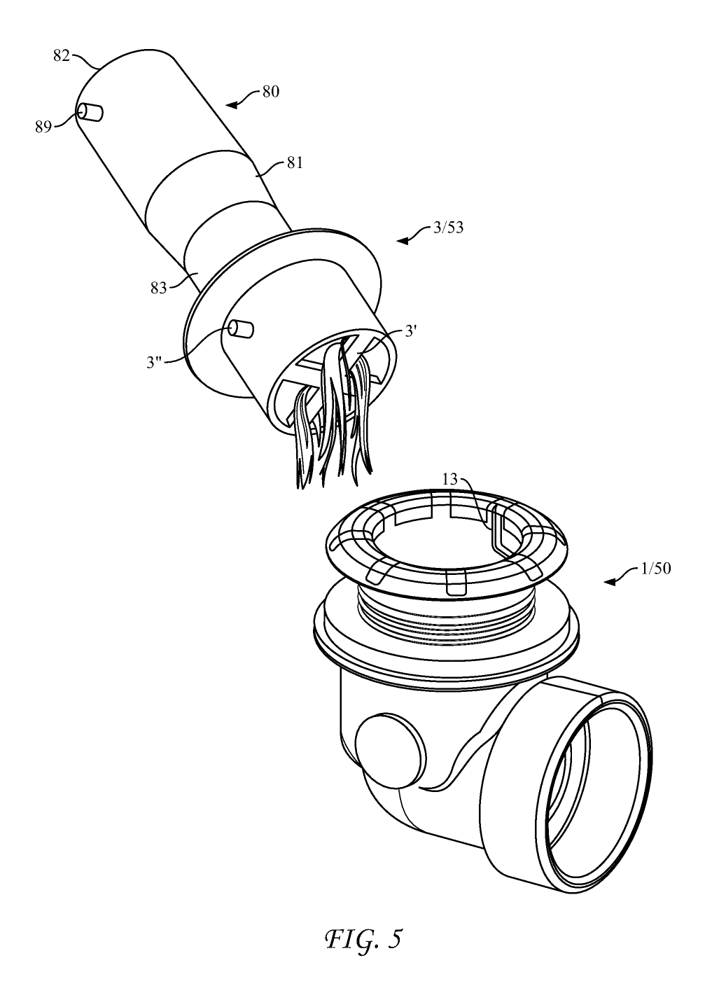

The spud body (11) further includes an attachment mechanism intended to interact with the complementary attachment mechanism in the elbow pipe (90). As described above and for ease of reference to the Figs., this attachment mechanism is illustrated as exterior threading (19) that extends about the periphery of the spud body (11). The exterior threading (19) is sized and dimensioned to threadedly engage the threaded interior (95) of the elbow pipe (90) (see FIG. 6). Once the threads are engaged, the flexible spud (10) may be positionally adjusted relative to the elbow pipe (90). In particular, when the complementary threads are engaged, rotation of the flexible spud (10) relative to the elbow pipe (90) will adjust the distance between the flexible spud (10) and the elbow pipe (90). The spud body (11) further includes an engagement feature (13) that extends into the inner surface of the flexible spud (10). As partially illustrated in FIG. 4, the engagement feature (13) is a pair of diametrically opposed slots in the inner surface of the flexible spud (10) that are configured to engage with complementary engagement feature (89), illustrated as pin-type projections, of a plumbing tool, such as a spud tool (80) (see FIGS. 5-6), as will be described in greater detail below. Although a pin/slot engagement feature may be described with respect to this and other engagement features described below, one of skill in the art will readily understand that any other suitable engagement feature may be substituted that similarly permits detachable locking between the engaged components. As shown in FIG. 4, the slots (13) extend downward into the inner surface of the flexible spud (10) and further that they continue circumferentially about a portion (for example ¼ or a quarter) of the circumference of the inner surface.

As shown in greater detail in FIG. 4, the flexible spud (10) further includes a flexible ring portion (14) integrally attached to the spud body (11) at the top portion. The flexible ring portion (14) has a maximum outer diameter (measured with respect to the longitudinal central axis (12)) that is greater than an outer diameter of the spud body (11) (also measured with respect to the longitudinal central axis (12)). The flexible ring portion (14) generally comprises two different materials, although the ring (14) could similarly comprise a single material or more than two materials as necessary.

With continued reference to FIG. 4, the flexible ring (14) comprises a flexible rubber material (15) disposed about a rigid frame (16) which comprises a structural plastic material. As shown in the Figure, the rigid frame comprises the same material as the illustrated cylindrical spud body (11). One of skill in the art will readily understand that the rigid frame (16) may alternatively be constructed of a different material or combination of materials as deemed appropriate under the circumstances. Likewise, the flexible rubber material (15) may alternatively be constructed of a different material so long as the material has flexible properties. As shown, the flexible ring (14) is integral with the cylindrical spud body (11) at the top portion. However, one of skill in the art will readily understand that a portion (particularly, the rigid frame (16)) may be non-integral (i.e., separable) from the spud body (11) such that it may be interchangeable with other flexible rings (14) as appropriate or as necessary.

As shown, the flexible ring portion (15) defines an outer tapered section (17) which tapers downwardly and away from the longitudinal central axis (12). As will be described in further detail below with regard to an installation method (FIG. 6), the tapered outer section (17) is configured to flex inwardly (toward the axis (12)) during installation into the tank (25) so as to temporarily reduce the outer diameter (D₁) of the flexible ring (14) to a reduced diameter (D₂), until the entirety of the flexible ring (14) is disposed inside of the tank (25), at which point the flexible ring (14) resumes its initial outer diameter (D₁) and its previous shape. When the tapered section (17) bears upon the inner wall of the tank, the tapered section flexes upwardly to create a liquid-proof seal.

It is contemplated that the attachment system described above may further include a spud tool and a trim kit. In this regard, the system may form a kit that contains all components and tools to install the plumbing assembly described above and as shown in FIG. 1.

With reference now to FIG. 5, a plumbing tool, such as spud tool (80), and trim kit (3/53) are illustrated according to a first embodiment. The spud tool (80) comprises an elongate body (81) that is substantially cylindrical along a tool axis. As shown in the Figure, the spud tool extends between opposed first and second ends (82, 83). The elongate body at the first end (82) comprises an engagement feature (89) that is complementary to the engagement feature (13) contained within the flexible spud (10), as described above. As illustrated, the engagement feature (89) is a pair of diametrically opposed pin-type projections that extend radially outward from the elongate body (81) (with respect to the tool axis) such that the projections (89) are sized and dimensioned to interact with the slots (13) of the flexible spud (10). In this manner, and as will be described below with respect to the method of installation, the projections (89) of the spud tool (80) may engage with the slots (13) of the flexible spud (10) so as to impart rotational movement about the tool axis to thereby cause the flexible spud (10) to ride along the threading (95) of the elbow pipe (90) so as to shorten (i.e., reduce) or lengthen (i.e., enlarge), as necessary, the distance between the flexible spud (10) and the elbow pipe (90). As illustrated in FIG. 5, the elongate body (81) at the second end (83) has a smaller cross-sectional dimension than the elongate body (81) at the first end (82). In other words, the second end (83) of the spud tool (80), as illustrated, is narrower than the first end of the spud tool. The elongate body (81) at the second end (83) further comprises an engagement feature (88) (see FIG. 6) that is complementary to an engagement feature contained within the trim, (not shown, but as described below). As shown in FIG. 6, the engagement feature (88) at the second end (83) is a pair of diametrically opposed pin-type projections that extend radially outward from the elongate body (81) (with respect to the tool axis).

The trim kit (3/53) (or simply “trim”) comprises a generally cylindrical trim body that extends downwardly from a top portion to a bottom portion along a trim axis, the body generally defining an outer cylindrical surface (outer trim surface). The trim has a hollow bore extending along the axis through the trim body, the hollow bore being defined by an inner cylindrical surface (inner trim surface). In the embodiment shown in FIG. 5, the trim body further includes at least one, but preferably two, cross bars (3′) that extend across the inner trim surface at the bottom portion. When the trim is installed, the cross bars function as debris filters, which is that they are capable of “catching” debris (such as hair) that would otherwise proceed deeper into the plumbing system with the flow of liquid as described above, potentially causing a clog over an extended period of time. The trim body further includes an outer engagement feature (3″) defined by the outer trim surface and an inner engagement feature (not shown) defined by the inner trim surface. In a particular embodiment and with reference to FIG. 5, the outer engagement feature (3″) comprises a pair of diametrically opposed pin-type projections that extend radially outward (with respect to the trim axis) from the outer trim surface. These projections (3″) are configured to engage with the complementary slots (13) of the flexible spud (10) (described above) by advancing the projections (3″) of the trim (3/53) downwardly through the slots of the flexible spud (10) and further by advancing them rotationally through the circumferential portion of the slot (for example, a quarter turn). In a certain embodiment, the inner engagement feature of the trim (not shown) is a pair of diametrically opposed slots which are configured to engage with the complementary projections at the narrower second end of the spud tool.

A method of installing the attachment system is illustrated in FIG. 6, and will now be described in greater detail. As illustrated in step 1, a pre-assembled plumbing assembly (1/50) is provided, substantially as described above. It is understood that assembling the preassembled assembly (1/50) may be performed by the user prior to installation in the tank (25) or otherwise, (e.g., by being purchased in the pre-assembled condition). Regardless of source, the pre-assembly may be accomplished by interconnecting the flexible spud (10) with the elbow pipe (90) and the gasket (4). Thus the pre-assembled assembly (1/50) includes the elbow pipe (90), the gasket (4), and the flexible spud (10). The assembly (1/50) is inserted along a direction of insertion (upwardly as illustrated by the arrow in the Figure) toward a hole (26/27) in the tank (25) (or tub).

With continuing reference to FIG. 6, and as illustrated in step 2, the flexible ring portion (14) of the flexible spud (10) bears against an outer surface (28) of the tank at an edge of the hole (26/27) so as to cause the flexible ring portion (14) to flex inwardly toward the body (11) (also toward the central axis (12)) of the flexible spud (10) so as to temporarily reduce the outer diameter of the flexible ring portion (14) from an initial outer diameter (D₁) to a reduced diameter (D₂). It should be noted that in its unreduced state, the diameter of the flexible ring portion (D₁) is greater than the diameter of the hole (26/27) in the tank (25), whereas in its reduced state, the reduced diameter (D₂) of the flexible ring portion (14) is substantially equal to (but not greater than) the diameter of the hole (26/27). It is because of the reduction in diameter that the entirety of the flexible ring portion (14), and hence a desired remainder of the flexible spud body (11), may pass through the desired hole (26/27) and into the interior of the tank. After the entirety of the flexible ring portion (14) passes into the interior of the tank, the flexible ring portion (14) flexes outwardly away from the body (11) (as well as away from the central axis (12)) of the flexible spud (10) so as to once again define its original (initial) outer diameter (D₁).

With continuing reference to FIG. 6, and as illustrated in step 3, the engagement feature (89) (i.e., the pin-type projections) of the first end (82) of the spud tool (80) is engaged with the complementary engagement feature (13) (i.e., the slots) of the flexible spud (10). The spud tool (80) is then rotated about the tool axis so as to cause the flexible spud (10) to ride along the inner threading (95) of the elbow pipe (90) to thereby reduce the distance between the flexible spud (10) and the elbow pipe (90) as measured along the direction of insertion. As shown in step 3, the rotation is discontinued when both (1) an upper surface of the gasket (4) abuts the outer surface (28) of the tank (25) adjacent to the hole (26/27), and (2) a bottom of the flexible ring portion (14) contacts an inner surface (29) of the tank (25) so as to cause the flexible ring portion (14) to flex outwardly from the flexible spud body (11) (and the central axis (12)) so as to define an augmented diameter (D₃) that is greater than the its original diameter (D₁). The outward flexing of the flexible ring portion (14) against the inner tank surface (29) creates a liquid-proof seal with the inner tank surface (29). The engagement feature (89) of the first end (82) of the spud tool (80) may then be disengaged (i.e., removed) from the complementary engagement feature (13) of the flexible spud (10).

With continuing reference to FIG. 6, and as illustrated in step 4, the engagement feature (88) (i.e., the pin-type projections) of the narrower, second end (83) of the spud tool (80) may be engaged with the complementary engagement feature (i.e., the slots) (not shown) of the inner surface of the trim (3/53). The engaged trim (3/53) and spud tool (80) are then introduced into the flexible spud (10) such that the engagement feature (3″, see FIG. 5) of the outer surface of the trim (i.e., the pin-type projections) is engaged with the engagement feature (88) of the spud tool (80). The spud tool (80) is then rotated so as to cause the engagement feature (3″, see FIG. 5) of the outer surface of the trim (3/53) to engage a circumferential portion of the engagement feature of the flexible spud (10) so as to positionally fix the trim (3/53) relative to the flexible spud (10). Finally, the engagement feature (88) of the second end (83) of the spud tool (80) is disengaged (i.e., removed) from the complementary engagement feature (not shown) of the trim.

As indicated above, it is contemplated that the plumbing assembly system of the first embodiment will come pre-assembled prior to an insertion method. In other words, the flexible spud (10) may be pre-inserted into the elbow pipe (90) and the gasket (4) will be disposed on the flange of the elbow pipe when a user installs the system. It is understood, however, that the pre-assembly may be accomplished by the user prior to installation or otherwise, e.g., by being purchased in the pre-assembled condition. It is also contemplated that during the insertion process, once a user has performed the first inserting step but has not yet performed the first engaging step, the user may hang the pre-assembled assembly from the hole (26/27) in the tank (25), as shown in step 2. This is advantageous because while the elbow pipe maintains its location inserted in the hole of the tank, a single user may have use of both hands to effectuate other installation tasks, such as but not limited to installing other pipe constructs or parts. It is further contemplated that the spud tool be multi-functional, performing such tasks as installing the attachment systems (as elaborated above), cleaning the drain when it becomes clogged, and quickly changing the trim (3/53) as desired by the user. As explained above in regard to the engagement of the trim (3/53) with the flexible spud (10), it is further contemplated that the trim (3/53) may be locked into place in the flexible spud (10) by performing a quarter turn (i.e., rotation) during installation so that the trim (3/53) will be positionally fixed relative to the flexible spud (10), although other means of fixing the position of the trim (3/53) are contemplated.

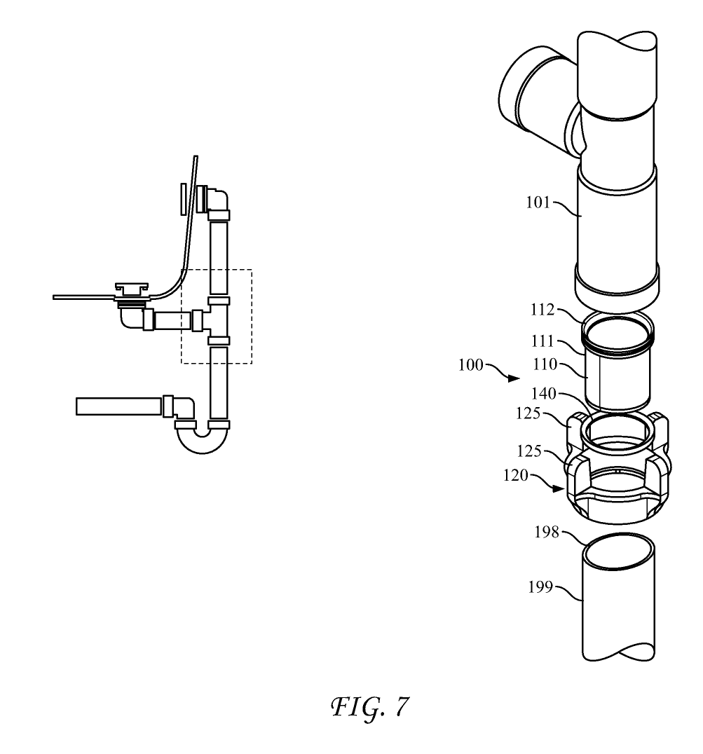

Turning now to FIG. 7, a plumbing attachment system (100) according to a second embodiment is illustrated. As compared to the system of the first embodiment shown in FIGS. 1-6, the system according to the second embodiment is configured to replace and/or repair existing pipe constructs at a location other than the drain and overflow. More particularly, as shown in FIG. 7, the system (100) according to the second embodiment installs in and over an existing pipe (199) so as to create a seamless transition between a newly installed pipe (101) and existing pipe (199). This is important so as to reduce and/or eliminate clogging which is known to occur at junctions between two non-contiguous pipes. As shown in FIG. 7, an exploded view shows the system's components, which include a newly installed (or simply new) pipe (101)—illustrated as a modified repair tee (or simply “a tee pipe”)—, a drain gasket (110), a collar (120) having extended tabs (125), and a compression gasket (140).

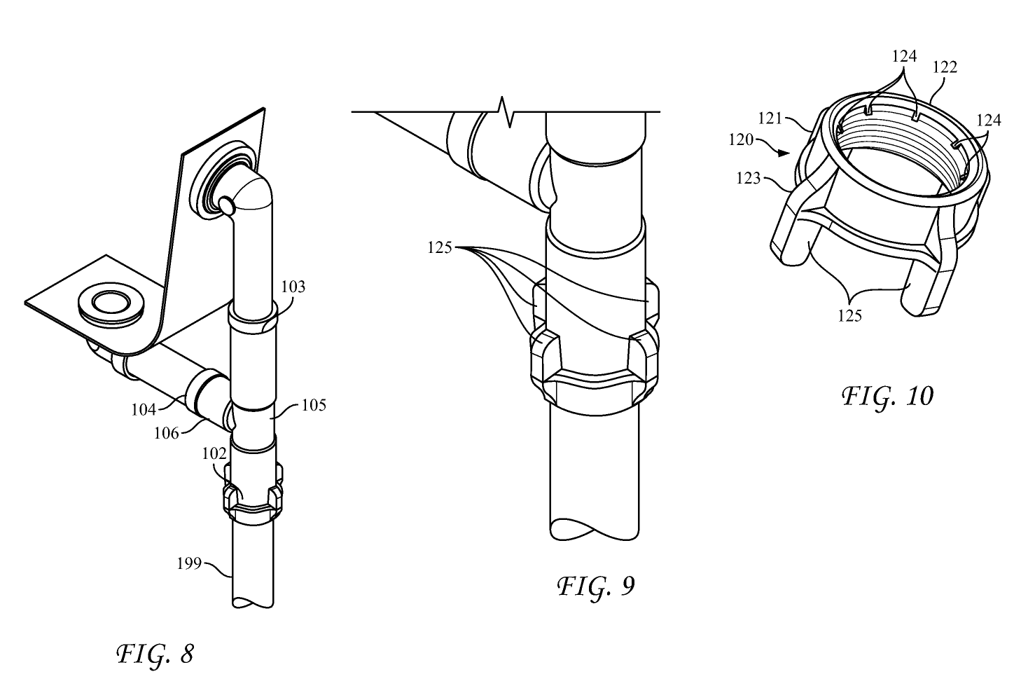

Referring now to FIG. 8, the system (100) is shown in an assembled configuration (as will be described in greater detail below). As illustrated, the new pipe (101) (hereinafter, the tee pipe) has a pipe body that defines a generally circular cross section and a hollow interior. Although reference will be made hereafter to a tee pipe (101) as illustrated, it is contemplated that the new pipe (101) may have any configuration and orientation, such as, for example, a straight pipe section having a singular segment and two opposing openings. Similar to tee pipes generally known in the art, the illustrated tee pipe (101) is a connector pipe that permits attachment of up to three pipe constructs. Hence, the tee pipe (101) has three openings at respective ends of the tee pipe (101). For ease of reference, the bottom and top openings as illustrated will be referred to as first and second openings (102, 103), respectively, and the left-most opening will be referred to as a third opening (104). The first and second openings (102, 103) are separated from one another along a first pipe segment (105) and the third opening (104) is separated from the first pipe segment along a second pipe segment (106) that, as illustrated, is perpendicularly oriented relative to the first segment (105). One of skill in the art will readily understand that the pipe segments (105, 106) may have other angular configurations as necessary for the plumbing job in question. Each of the second and third openings (103, 104) are individually configured to receive other pipe constructs by means of a press-fit connection, although other forms of attachment are contemplated. In any event, as illustrated in FIG. 8, the tee pipe (101) is configured to allow liquid to flow through the interior of the tee pipe (101) from into the second and third openings (103, 104) and out of the first opening (102). In a particular embodiment, the first pipe segment (105) near the first opening (102) has a larger cross-sectional inner diameter (across the inner hollow portions) and outer diameter (across the outer surfaces) than the first pipe segment (105) near the second opening (103). Importantly, the cross-sectional inner diameter is larger than a cross-sectional outer diameter of an existing pipe (199), such that the first opening (102) may encapsulate a top portion of the existing pipe structure (199) to thereby join the tee pipe (101) to the existing pipe structure (199).

Referring back to FIG. 7, the drain gasket (110) is illustrated as having a generally cylindrical body (111) that extends from a top portion to a bottom portion along a gasket axis. The gasket (110) is preferably made of a flexible material, such as by way of non-limiting examples: rubber or plastic. As shown, the gasket body has an outer cylindrical wall (111) and is hollow in its center so as to allow liquid to pass completely though the drain gasket (110). At the top portion on the cylindrical wall (111), the drain gasket (110) includes a sealing element (112). The sealing element (112) may be thought of as a lip that extends radially outward from the gasket body relative to the gasket axis. In this manner, the sealing element (112) defines a cross-sectional diameter that is greater than a cross-sectional diameter of the cylindrical wall (111) of the drain gasket (110). The respective outer diameters of the sealing element (112) and the cylindrical wall (111) are sized and dimensioned so as to closely match the inner diameters of the tee pipe (101) at the first opening (102) and the existing pipe (199), respectively. In other words, and as will be explained in greater detail below with regard to a particular installation method, the cross-sectional diameter of the sealing element (112) is substantially equal to (but not greater than) the cross-sectional inner diameter of the first pipe segment (105) near the first opening (102), and the cross-sectional diameter of the cylindrical wall (111) is substantially equal to (but not greater than) a cross-sectional inner diameter of the existing pipe (199). The close-matching nature of diameters in this respect allows the drain gasket (110) to form a liquid-proof seal at these locations so as to prevent liquid from leaking in the pipe constructs when liquid flows through them. A key feature of the drain gasket (110) is that it may additionally be inserted over an existing pipe (199) having a roughly cut or uneven top edge (198). Because the drain gasket (110) comprises a flexible material, the sealing element (112) at the top portion is able to flex during installation in order to maintain surface contact with the top edge (198) and thus to maintain a liquid-proof seal with the existing pipe (199).

Referring now to FIGS. 8-10, the collar (120) is illustrated as having a generally cylindrical body (121) that is elongate along a collar axis from a top portion (122) to a bottom portion (123). The collar (120) includes a bore extending through the center of the body (121) and a series of tabs (125) extending longitudinally out of the top portion (123) of the collar body (121). As illustrated in the Figures, the collar (120) includes four tabs (125), although one of skill in the art will readily understand that any number of tabs (125) may be included on the collar (120). With particular reference to FIG. 10, the collar body (121) further defines a friction mechanism at the bottom portion. As illustrated in the Figure, the friction mechanism comprises a series of teeth (124) that are sized and dimensioned to frictionally secure the collar (120) to an exterior surface (197) of the existing pipe (199) in the assembled configuration. One of skill in the art will readily understand that any other type of friction mechanism may alternatively be used, providing that the friction mechanism is capable of positionally securing the collar (120) relative to the existing pipe (199) in the assembled configuration.

Once again referring back to FIG. 7, the compression gasket (140) is illustrated as a substantially circular ring. The compression gasket (140) is preferably made of a plastic or rubber material, although one of skill in the art will readily understand that any suitable flexible material know in the art may be used. The compression gasket (140) is sized and dimensioned to be received in and cooperate with the collar (120) so as to create a liquid-proof seal between the tee pipe (101) and the existing pipe (199) in the assembled configuration.

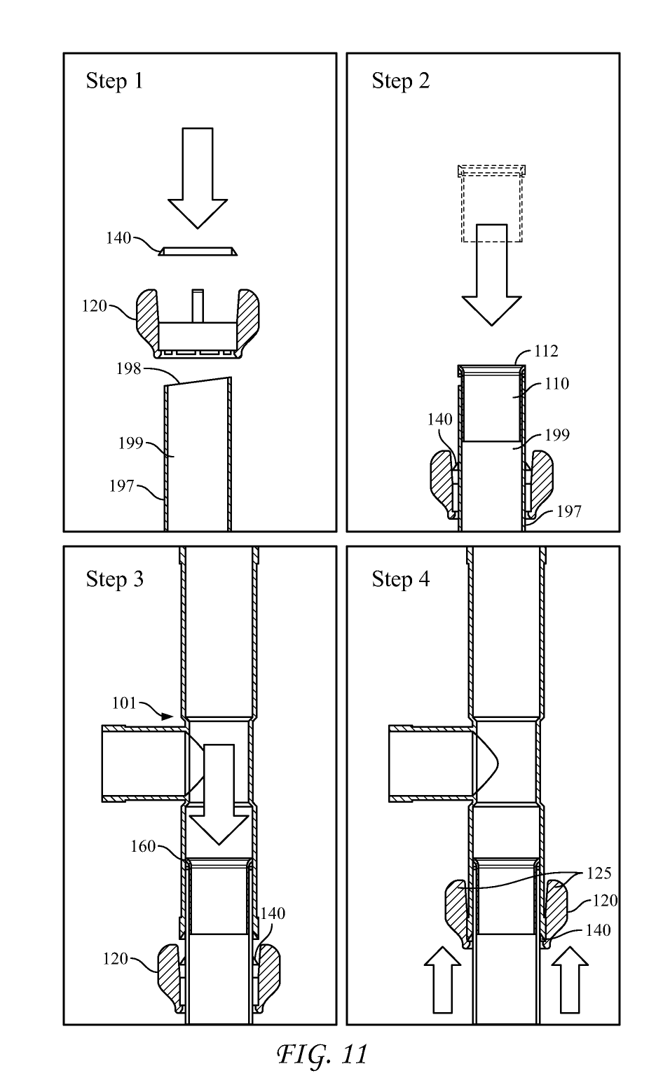

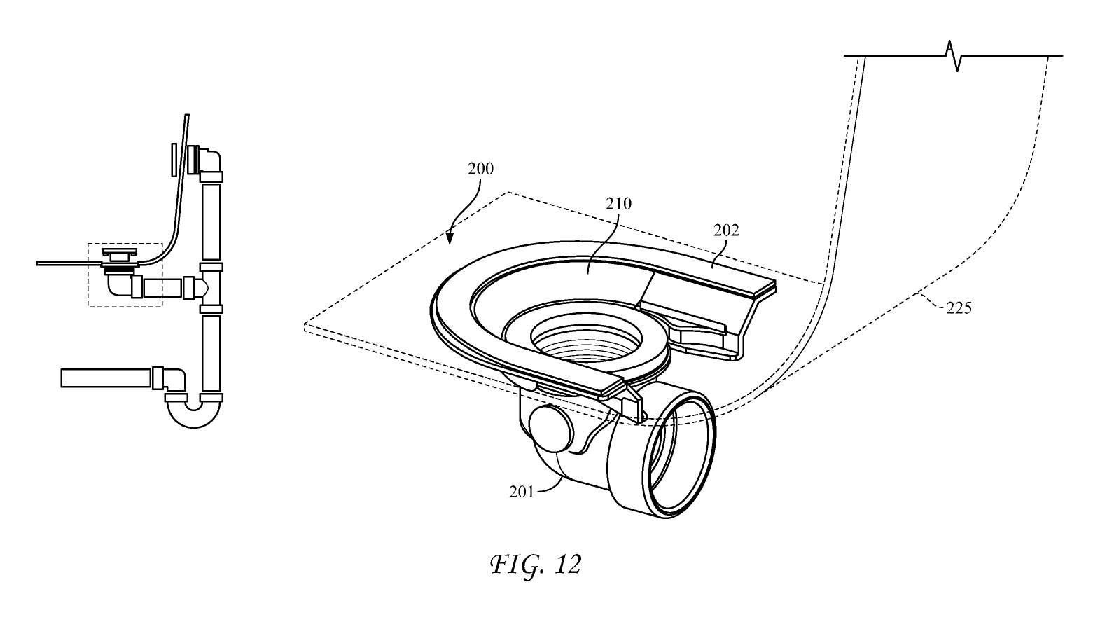

Although an installation method will be described in more detail below, it is important to understand how the components of the system relate to one another in the assembled configuration. Referring to FIG. 11, in the assembled configuration, the drain gasket (110) is received within the existing pipe (199) such that a bottom surface of the sealing element (112) abuts a top edge (198) of the existing pipe (199) so as to create a first liquid-proof seal therebetween. In that manner, the sealing element (112) maintains full surface contact with the top edge (198) of the existing pipe (199). The existing pipe (199) is received within the first pipe segment (105) of the tee pipe (101) at the first opening (102) to define a juncture point (160) where the first opening overlaps the existing pipe (best shown in step 3). Finally, the collar (120) receives the compression gasket (140) and slides along the existing pipe (199) to create a compressive force at the juncture point (160) to thereby create a second liquid-proof seal between the tee pipe (101) and the existing pipe (199).

A method of installing the attachment system is illustrated in FIG. 11, and will now be described in greater detail.

With continuing reference to FIG. 11, and as illustrated in step 1, the collar (120) is inserted downwardly (in the direction of the arrow) onto and thereby around an exterior cylindrical surface (197) of the existing pipe (199). As shown in step 1, the existing pipe (199) was formerly cut so as to define an uneven top edge (198). Next, the compression gasket (140) is also inserted downwardly onto and thereby around the exterior surface (197) so that the gasket is disposed on the existing pipe (199) above the collar (120). As the collar is situated on the exterior cylindrical surface (197) of the existing pipe (199), the friction mechanism (e.g., the array of teeth (124) shown in FIG. 10) extends partially into the exterior surface (197) so as to thereby limit translation of the collar (120) with respect to the existing pipe (199).

With continuing reference to FIG. 11, and as illustrated in step 2, the drain gasket (110) is then secured to the existing pipe (199) at the top edge (198). The sealing element (112) of the drain gasket (110) is sized and dimensioned to sit directly on the top edge (198) and the cylindrical wall (111) of the gasket (110) is sized and dimensioned to sit snugly within an inner portion of the existing pipe (199).

With continuing reference to FIG. 11, and as illustrated in step 3, the tee pipe (101) at the first opening (102) is fit over the existing pipe (199) near the top edge (198). Because the sealing element (112) has a diameter that is substantially equal to the inner cross-sectional diameter of the tee pipe (101) near the first opening (102), a first liquid-proof seal is created between the tee pipe (101) and the drain gasket (110) at the circumferential point of contact therebetween. The intersection point created by the first opening (102) and the exterior surface (197) of the existing pipe (199) defines a juncture (160).

With continuing reference to FIG. 11, and as illustrated in step 4, the collar (120) and compression gasket (140) are translated upward (as shown by the arrows) along the exterior cylindrical surface (197) of the existing pipe (199) such that the collar (120) cooperates with the compression gasket (140) to create an inwardly directed compressive force at the juncture (160). This compressive force functions to both: (1) positionally fix the tee pipe (101) relative to the existing pipe (199), and (2) create a second liquid-proof seal. The tabs (125) of the collar (120) may aid a user in translating the collar (120) upward by creating additional surface area for a user to grab and tighten during the installation process.

It is contemplated that the plumbing attachment system of the second embodiment could also be part of a kit comprising the various components in varying sizes so as to accommodate existing drain pipes and constructs of all sizes. Because all components in the second embodiment are slip-fit and hand-tightened, the use of plumbing tools is not required or necessary. It is further contemplated that a user performing an installation of the second embodiment could first perform a removal step in order to excise the existing pipe constructs so that they may be replaced with the system of the second embodiment. At the least, a user may need to cut old, existing pipes prior to installation of the system, which may partially form the top edge (198) of the existing pipe (199), as described above. It is also contemplated that some or all of the components of the system may be capable of flexing, and as such, they may be made of materials that have rigid and flexible properties. In that manner, a flexible system could be useful to a user installing the attachment system in certain repair scenarios.

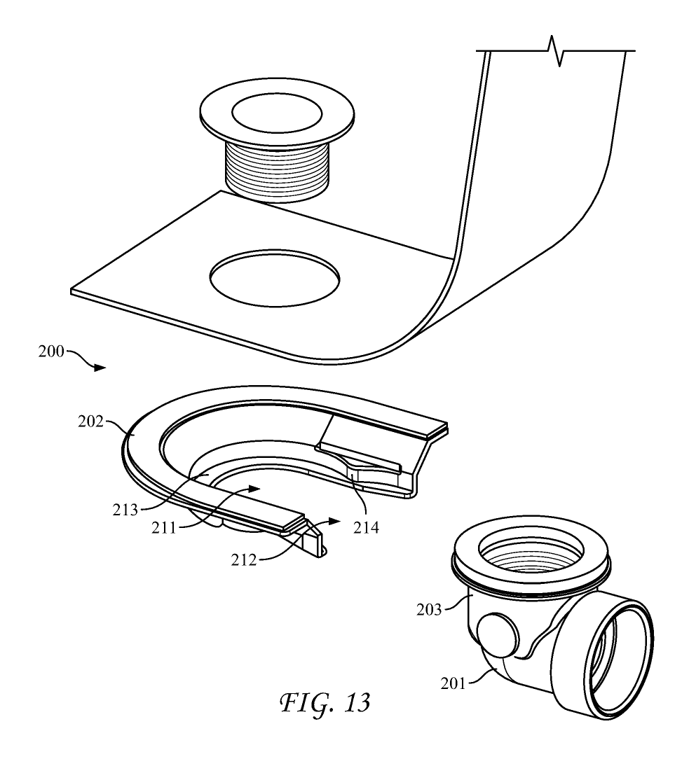

Turning now to FIGS. 12-13, a pipe-guiding connector (200) according to a particular embodiment is illustrated. The pipe-guiding connector (200) serves the function of positioning and aligning a pipe (as illustrated, an elbow pipe (201)) with a hole of a tank (225) in order to facilitate installation of the elbow pipe (201). To accomplish this (and as will be described in more detail below), the pipe guiding connector (200) comprises an attachment mechanism (202) at an upper tank-facing surface that fixedly attaches the connector to an outer surface of the tank (225) prior to guiding the elbow pipe (201) along the connector (200) and toward the hole of the tank (225). As illustrated, the attachment mechanism (202) is an adhesive strip, but any other suitable attachment means may be used so as to permit the connector (200) to adhere onto the outer surface of the tank (225). In this manner, one of skill in the art may consider the pipe-guiding connector (200) to function as a “third hand” because it allows a user to make usage of both hands during installation of the elbow pipe (201) as it is being held in the proper location by the connector (200).

With continuing reference to FIGS. 12-13, the connector has a generally horseshoe-shaped body (210) that includes both a pipe-holding portion (211) and pipe-guiding portion (212). The pipe-holding portion (211) refers to the location of the connector (200) that corresponds to the location of the hole of the tank (225) once the connector (200) has been mounted to the tank (225). In other words, the elbow pipe (201) will sit in the pipe-holding portion (211) as it is being mounted to the tank (225). The pipe-guiding portion (212) by contrast effectively functions as a guide track along which the elbow pipe (201) may be slid into the pipe-holding portion (211). The body (210) has a shelf (213) that is sized and dimensioned to abut a lower flange surface (203) of the elbow pipe (201) such that the lower flange surface (203) may ride along an upper surface of the shelf (213) from the pipe-guiding portion (212) toward the pipe-holding portion (211).

The pipe-guiding portion (212) further includes a locking mechanism (214) that engages with the elbow pipe (201) so as to retain the elbow pipe (201) within the pipe-holding portion. As illustrated in FIG. 12 specifically, the locking mechanism (214) may comprise a pair of flexible tabs (214) that extend partially over a portion of the surface of the shelf (213) so as to urge the elbow pipe (201) into the pipe-holding portion (212) and further to lock it into place (as will be described in greater detail in the installation method recited below). Although the illustrated embodiment depicts the locking mechanism (214) as a pair of flexible tabs (214), one of skill in the art will readily understand that other locking mechanisms may be used, such as by way of non-limiting examples: springs, ball detents, adhesives, etc.

Although not illustrated in FIGS. 12-13, the connector (200) may further include a removable intermediate portion that integrally connects the upper tank-facing surface and the shelf, such that removal of the intermediate portion separates the upper tank-facing surface from the shelf. As further indicated in the method below, a user may optionally choose to remove the intermediate portion so as to remove a substantial entirety of the guiding connector (200) from the tank (225). Removal of a substantial entirety of the connector (200) may be advantageous after a user has installed the elbow pipe (201).

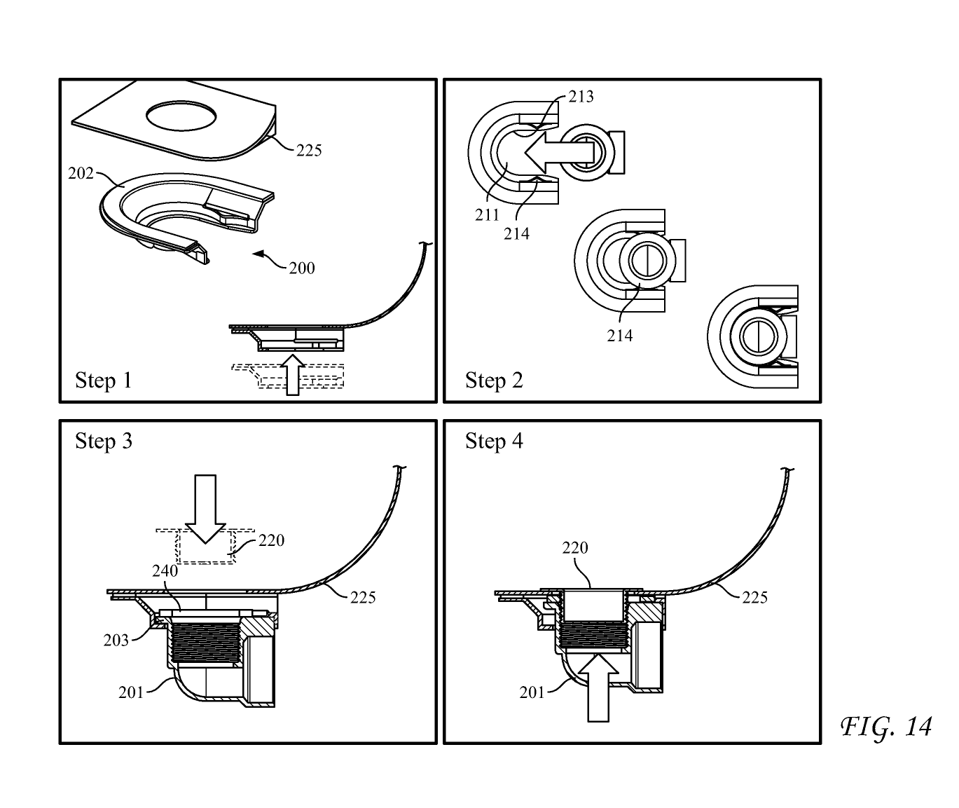

A method of installing the pipe-guiding connector (200) is illustrated in FIG. 14, and will now be described in greater detail. As shown in step 1, the connector (200) is adhered onto the outer surface of the tank (225) by means of the adhesive strip (202).

As shown in step 2, the elbow pipe (201) is then slid along the surface of the shelf (213) at the pipe-guiding portion (212) so as to engage with the flexible tabs (214). As shown in the Figure, the flexible tabs (214) flex outwardly as a lower flange surface (203) of the elbow pipe (201) bears against them while the elbow pipe (201) translates along the surface of the shelf (213) at the pipe-guiding portion (212) toward the pipe-holding portion (211). Once the elbow pipe (201) is in the pipe-holding portion (211) of the connector (200), the flexible tabs (214) relax and return to their initial position, thereby holding the elbow pipe (201) positionally fixed in the pipe-holding portion (211). The flexible tabs (214) are configured so as to exert a constant inward force while they are flexed outwardly. This inward-directed force helps “urge” the elbow pipe (201) into the pipe-holding portion (211) and it also helps to retain the elbow pipe (201) therein.

With continuing reference to FIG. 14 and as shown in steps 3 and 4, a spud (220) may be installed and tightened into the elbow pipe (201) while it is being held in place by the connector (200). As shown particularly in step 4, tightening the spud (220), which as illustrated has complementary threading to match threading in the elbow pipe (201), causes the elbow pipe (201) to translate upwardly (as shown by the arrow in step 4) off of the surface of the shelf (213) at the pipe-holding portion (211) and toward the outer surface of the tank (225). The elbow (201) is fully tightened when a gasket (240) disposed on an upper surface of the flange bears against the outer surface of the tank (225).

As explained above, it is contemplated that the pipe-guiding connector (200) will behave as a “third hand” because it eliminates the need for an assistant or another work-around method to accomplish concurrent plumbing installations. It is further contemplated that the pipe-guiding connector (200) work with existing elbow pipes (201) or elbow kits that are commonly found in existing constructs. Alternatively, the connector as described could be used with the plumbing attachment system of the first embodiment described in detail above and as shown in FIGS. 1-6. The connector (200) may form part of a kit which includes other plumbing assemblies including but not limited to those described above. It is contemplated that the pipe-guiding connector (200) can be quickly and easily installed by a user not skilled in advanced plumbing techniques. It is contemplated that the connector (200) be a huge time-saver in that the connector can be installed before finishing up work inside the tube.

1. A plumbing attachment system for connecting a plumbing construct to a tank, the system comprising:
a pipe including a pipe body having a generally circular cross-section and a hollow interior, the pipe body extending between first and second openings at opposing ends of the pipe body, the pipe being configured to connect to the tank at the first opening and to an existing pipe construct at the second opening,; and
a flexible spud having a generally cylindrical spud body extending downwardly from a top portion to a bottom portion along a longitudinal central axis and a hollow bore portion extending through the spud body, the flexible spud including a flexible ring portion integrally attached to the spud body at the top portion, the flexible ring portion having a maximum outer diameter that is greater than an outer diameter of the spud body,
wherein the flexible ring portion includes a flexible material disposed about a rigid frame, the flexible ring portion defining an outer tapered section which tapers downwardly and away from the longitudinal central axis, such that when the flexible ring is connected to the tank at the first opening, the flexible ring is configured to provide a leak-proof seal between the system and the tank.

2. The system of claim 1, wherein the pipe body at the first opening further includes a threaded interior that extends into the pipe body, and wherein the spud body further includes a complementary exterior thread that is sized and dimensioned to threadedly engage the threaded interior of the pipe.

3. The system of claim 2, wherein a distance between the flexible spud relative to the pipe may be adjusted from a first distance to a second distance by matingly engaging the complementary exterior thread of the flexible spud with the interior thread of the pipe.

4. The system of claim 3, wherein the system defines a tank-engaged configuration when (1) the second distance is less than the first distance, and (2) the flexible ring portion of the flexible spud compresses against an inner wall of the tank so as to define the leak-proof seal.

5. The system of claim 3, further comprising:
a plumbing tool that includes an engagement feature sized and shaped to mate with a complementary engagement feature of the flexible spud, such engagement facilitating the adjustment of the distance.

6. The system of claim 1, further comprising a trim that is sized and dimensioned to couple to the flexible spud at the top portion.

7. The system of claim 1, further comprising:
a pipe-guiding connector sized and dimensioned to mate with the pipe so as to position the first opening in an attachment position for attachment to the tank, wherein the connector is configured to be secured to an outer surface of the tank, and wherein the connector includes a mating surface along which the pipe may be translated from a first position to the attachment position.

8-10. (canceled)

11. A plumbing attachment assembly comprising:
a new pipe having a pipe body extending between first and second opposed openings along a first pipe axis, the body defining a generally circular cross section and a hollow interior that defines a first diameter;
a drain gasket having a generally cylindrical gasket body extending from a top portion to a bottom portion along a gasket axis, the gasket body including an outer cylindrical wall extending about the gasket axis and having a second diameter that is substantially equal to an inner diameter of an existing pipe and that is less than the first diameter, the gasket body including a sealing element at the top portion, the sealing element extending radially outward from the gasket body relative to the gasket axis and having a second diameter that is greater than the first diameter and that is substantially equal to an inner diameter of the interior of the new pipe at the first opening;
a collar having a generally cylindrical collar body and a bore extending therethrough, the collar body extending from a bottom portion to a top portion along a longitudinal axis, the collar including at least two tabs extending longitudinally out from the top portion of the collar body and an array of teeth extending radially inward toward the longitudinal axis at the bottom portion of the collar,
a compression gasket that is sized and dimensioned to be received in and cooperate with the collar so as to create a seal between the new pipe and the existing pipe,

12. The assembly of claim 11, wherein the drain gasket is configured to be received within the existing pipe such that a bottom surface of the sealing element abuts a top edge of the existing pipe so as to create a first seal therebetween.

13. The assembly of claim 12, wherein the first opening is configured to receive the existing pipe so as to define a juncture point where the first opening overlaps the existing pipe.

14. The assembly of claim 13, wherein the collar cooperates with the compression gasket and is configured to slide along the existing pipe to create an inwardly compressive force at the juncture point, the force operating to create a second seal between the new pipe and the existing pipe, and wherein the teeth of the collar abut an exterior surface of the existing pipe so as to create a frictional force therebetween.

15. A method of installing a plumbing assembly comprising the steps of:
interconnecting a flexible spud with a pipe to define a pre-assembled plumbing assembly;
inserting the pre-assembled plumbing assembly along an insertion direction into a hole of a tank such that a flexible ring portion of the flexible spud is disposed within the tank, wherein the flexible ring portion creates a leak-proof seal with an inner surface of the tank;
engaging a tool with a complementary engagement feature of the flexible spud;
imparting momentum to the tool so as to reduce a distance between the flexible spud and the pipe, the distance being measured along the direction of insertion;
discontinuing the imparting step when both (1) a gasket disposed on a flange of the pipe abuts an outer surface of the tank adjacent to the hole, and (2) a bottom of the flexible ring portion contacts an inner surface of the tank adjacent to the hole, so as to create a leak-proof seal with the inner surface; and
disengaging the tool from the engagement feature of the flexible spud.

16. The method according to claim 15, wherein the inserting step further comprises the steps of:
pressing the flexible ring portion, having an initial diameter, against the outer tank surface at an edge of the hole so as to cause the flexible ring portion to flex inwardly toward a body of the flexible spud and thereby define a reduced diameter that is less than the initial diameter, wherein the hole has a diameter that is less than the first diameter but greater than the reduced diameter; and
passing an entirety of flexible ring portion through the hole and into the interior of the tank, such that the flexible ring portion flexes outwardly to once again define the initial diameter.

17. The method according to claim 15, further comprising, after the disengaging step:
engaging an engagement feature of a second tool with a complementary engagement feature of a trim;
introducing the engaged trim into the engagement feature of the flexible spud so as to positionally fix the trim relative to the flexible spud; and
disengaging the second tool from the engagement feature of the trim.

18. The method according to claim 17 further including the step of, prior to the second disengaging step:
imparting momentum to the second tool so as to engage an outer engagement feature of the trim with a second complementary engagement feature of the flexible spud.

19. A method of installing a plumbing assembly comprising the steps of:
inserting a collar and then a compression gasket onto and around an exterior cylindrical surface of an existing pipe so as to engage a friction mechanism;
securing a drain gasket to the existing pipe at a top edge thereof, the drain gasket having a cylindrical gasket body extending from a top portion to a bottom portion along a gasket axis, the gasket further including a bore extending completely therethrough, the bore being defined by an outer cylindrical wall, the gasket including a sealing element at a top portion of the body, wherein the sealing element is sized and dimensioned to be disposed on the top edge of the existing pipe and the outer cylindrical wall is sized and dimensioned to match a cross-sectional inner diameter of the existing pipe;
fitting an opening of a tee pipe over the existing pipe at the top edge so as to cause the exterior cylindrical surface of the existing pipe at the top end to thereby face an inner cylindrical surface of the tee pipe at the opening, wherein the intersection of the opening of the tee pipe with the exterior cylindrical surface of the existing pipe defines a juncture point, wherein a cross-sectional diameter of the tee pipe matches the diameter of the sealing element to thereby create a first seal between the tee pipe and the drain gasket at a point of contact between the two; and
translating the collar toward the juncture so as to secure the tee pipe to the existing pipe, wherein the collar cooperates with the compression gasket to create an inwardly directed compressive force at the juncture to both (1) positionally fix the tee pipe relative to the existing pipe, and (2) create a second seal.

20. The method of claim 19, wherein the friction mechanism is an array of teeth extending inwardly toward the exterior cylindrical surface to thereby limit translation of the collar with respect to the existing pipe.

21. The method of claim 18, wherein the translating step further comprises utilizing a tab disposed on the collar.

22. The method of claim 19, further comprising the step of:
prior to the first inserting step, cutting the existing pipe so as to expose the top edge.
